(19) United States
(12) Patent Application Publication
(10) Pub. No.: US 2025/0191396 A1
(43) Pub. Date: Jun. 12, 2025

(54) READING AN OPTICAL CODE

(71) Applicant: SICK AG, Waldkirch (DE)

(72) Inventors: Pascal SCHÜLER, Waldkirch (DE); Steffen ZOPF, Waldkirch (DE)

(21) Appl. No.: 18/977,725

(22) Filed: Dec. 11, 2024

(30) Foreign Application Priority Data
Dec. 12, 2023 (EP) 23215721.4

(51) Int. Cl. G06V 30/12; G06V 30/14

(52) U.S. Cl. CPC G06V 30/12; G06V 30/1437

(57) ABSTRACT

A method of reading an optical code is provided that encodes a message that has a character chain having a plurality of characters, said method comprising the steps: of recording image data having the optical code; evaluating the image data by reading the message, including a first check code read from the optical code; comparing the read characters of the message with at least one scheme that, for a plurality of positions of the message, contains a character that is expected at this position in optical codes to be read; and, when a minimum portion of the characters of the scheme is relocated in the message on the comparison, taking over characters of the scheme into the message. In this respect, a second check code of the message is determined after a taking over of characters from a scheme into the message; and the first check code is compared with the second check code to validate the message changed by taking over characters from the scheme.

The invention relates to a method of reading an optical code and to an optical reader.

Code readers are known from supermarket checkouts, for automatic parcel identification, for sorting mail shipments, from baggage handling at airports, and from other logistics applications. In a code scanner, a reading beam is guided transversely over the code by means of a rotating mirror or by means of a polygon mirror wheel. A camera-based code reader records images of the objects having the codes located thereon by means of an image sensor and image evaluation software extracts the code information from these images.

In an important application group, the objects bearing the code are conveyed past the code reader. A scanning code reader here detects the codes respectively successively led into its reading zone. Alternatively, in a camera-based code reader, a line scan camera reads the object images having the code information successively and linewise with the relative movement. As a rule, image data are recorded using a two-dimensional image sensor that overlap more or less depending on the recording frequency and on the conveying speed. So that the objects can be arranged in any desired orientation on the conveyor, a plurality of code readers are often provided at a reading tunnel to record objects from a plurality of sides or from all sides. A scanning code reader also detects the remission and thus ultimately image lines that can be assembled to form an object image, even though an image sensor is preferred for this purpose in practice. Code zones can be identified in such an object image and one-dimensional or two-dimensional codes can be read.

One of the most important quality criteria for a code reader or for a reading tunnel is a high reading rate. Reading errors make complex error remedies necessary such as the repeat manual scanning or a resorting. The cause for such errors can lie in the quality of the code itself, in an unfavorable reading situation, for example with a code under a film that causes reflections, and finally also in evaluation errors, for instance as part of the binarization of gray values or in the form of imprecisely calculated scanning positions.

To avoid reading errors, conventional decoders for two-dimensional codes such as DataMatrix, QR, Aztec, Maxicode, Dot Code, or also stack codes such as PDF417 and MicroPDF, are equipped with a Reed Solomon correction. This enables a powerful correction process by which even codes having larger area defects are still read correctly. Codes that are otherwise not readable (NoRead) are thus nevertheless read and so-called MisReads are also avoided. A code is incorrectly read here and this is not recognized. This practically does not occur with a Reed-Solomon correction. If its error capacity is exceeded, the corresponding code can no longer simply be decoded (NoRead).

The Reed-Solomon correction is not available for barcodes. In this respect, the term barcode should be understood as a 1D barcode; in the literature, 2D codes are sometimes also variationally called barcodes. The reading of a barcode is typically verified by means of a checksum. If the checksum calculated from the read useful data and the read checksum agree, a correct decoding is assumed. A deviation means that at least one character in the useful data or in the checksum was read incorrectly and this as a rule has the result of a reading error (NoRead).

It is possible to correct an individual non-decoded or defective utility character via the checksum, i.e. to retroactively set the affected utility character in a kind of inversion of the checksum process to a value with which then the checksum calculated from the utility data agrees with the read checksum. This form of correction is restricted to a single character and is not usable for larger area impaired codes. It then remains as a reading error (NoRead).

Since a checksum only intercepts single errors, the conventional correction for barcodes is vulnerable in situations with multiple errors. It is, however, not even unusual in practice for a code to be impaired at a number of points. Examples are very wavy surfaces with flexible packing materials such as cartons, in some cases in barcode labels adhered in a cardboard fold or barcodes under a film with pronounced reflections with a large number of local, areal defects.

A method of reading an optical code is advanced in EP 3 428 835 B1 in which a code word is replaced with a code word known for a position at at least one position of the code in a pre-correction. The known code words are parameterized, are specified by a database of a higher ranking system, or are taught from a history of read codes.

EP 4 258 160 A1 expands this idea and introduces so-called schemes. Expectations of frequently occurring code constellations are formalized in a scheme, for example as regular expressions. Analogously to EP 3 428 835 B, there is a fixed portion here that corresponds to a fixed sequence of characters recurring in a large number of codes and a variable portion that detects more general rules such as that only numerals or only letters occur at specific positions. Schemes can be used to recognize a message read from an optical code as read incorrectly or to correct it.

However, cases occur in practice in this respect in which the correction by means of schemes does not result in the correct message or in which an error is even only introduced into an originally correctly read message by the correction. MisReads thereby then occur again.

It is therefore the object of the invention to further improve code reading with correction from a scheme.

This object is satisfied by a method of reading an optical code and by an optical code reader. It must be stated as a precaution that it is an automatically running process that is in particular implemented on a computer. The optical code contains a message, that is that clear text that should be communicated by the optical code and that is encoded therein. The message has a character chain having a plurality of characters. In addition to the utility character it contains a check code having at least one check character, for example a checksum that is called a first test code to distinguish it from a second check code introduced later. To read the code and thus the message, image data having the optical code are first recorded in one of the known manners described in the introduction. Code zones that segment the image data, for example using the contrast, are then preferably located in the image data by a pre-processing and the respective code in the code zones is decoded and the message thereby read together with the first check code.

The read characters of the message are compared with a scheme, preferably repeated with a plurality of schemes. The scheme expects a specific character at a plurality of positions of the message. Whether the scheme matches the message is determined by a comparison of the read characters of the message at these positions with the characters of the scheme. For this purpose, there must be agreement for a minimum portion of the characters expected by the scheme with the read characters of the message, for example for at least two, at least three, at least four, or even more characters or for a minimum portion of the characters expected from the scheme such as at least a third or at least half. If this is the case, characters of the scheme are taken over into the read message, preferably all the characters read by the scheme. In this respect, it is not the specific implementation of this overwriting that is important; for example, only characters differing between the scheme and the read message can be directly transmitted or all the characters fixed by the scheme simply overwrite the corresponding positions of the read message. Up to this point, the method is based on EP 3 428 835 B1 and EP 4 258 160 A1 to which reference is additionally made for further details and possible embodiments.

The invention starts from the basic idea of determining a second check code after a correction of the read message by means of a scheme. This is done according to the rules of the code type of the optical code to be read by which the first check code contained in the optical code was also originally calculated. The second check code thus checks the message corrected by the scheme and not the original read message as typical for a check code. If the first check code and the second check code agree, the message corrected by the scheme is validated. The reaction to the validation or non-validation can differ; for example, a corresponding flag is output as additional information with the message or, in the event that it is not possible to validate, the read message is not output at all, is reported as a reading error, or still further decoding attempts are thereupon made.

The invention has the advantage that whether the correction on the basis of the scheme was successful can be determined or validated using the second check code. It could have been insufficient, as already explained in the introduction, or it could even falsify an originally correctly read message. If the validation fails, the reading error is at least revealed and a false message is not further processed as corrected without being recognized. Alternatively, the original read message is forwarded as the result of the code reading; the failed correction by the scheme is thus effectively withdrawn. Since there is now a validation possibility, extensive corrections by a scheme can be risked so hat optical codes that are even more damaged possibly become readable. Particularly when there are a large number of schemes, it is possible that a plurality of schemes match a read message and the validation can also help and make the correct selection in this case. Fewer reading errors thus occur overall; the reading rate is improved.

The first check code is preferably considered as read correctly when the first check code is within a permitted value range, when the same first check code results in at least a majority of cases with a redundant multiple reading, and/or when directly adjacent characters of the check code were read. Since the validation is based on the first check code, it is particularly important the first check code is correct. An error in the detection of the first check code could result in an incorrect validation and should therefore be excluded as much as possible. For this purpose, different check steps are proposed that can be used individually or in any desired combinations. The check code should be within a permitted value range. It is usual that a code is read redundantly a multiple of times. In this respect, however, the resulting message is then looked at, no longer the individual check code of a respective reading attempt. In accordance with this embodiment, in contrast, it is required that the check code itself agrees in the majority of the reading attempts and preferably in all the reading attempts. The directly adjacent characters of the check code can furthermore be checked as to whether they have been reliably detected, in particular in a redundant multiple reading in a majority of cases or always as the same character. Due to the correction mechanisms, it is by all means conceivable that the adjacent characters have been reconstructed; here it is a question of whether they were themselves directly readable for if this is the case, the region of the check code is likewise not damaged or unreadable for other reasons with a high likelihood. The following character is a stop character as a rule.

The message is preferably first read in raw values from optical elements of the optical code, with the raw values then being converted into the characters of the message using an encoding scheme. The raw values are numerical values that result from the code elements or in particular bars and gaps of the optical code. Every code type moreover has an encoding scheme or an alphabet by which these raw values are interpreted. A specific ASCII character is associated with a raw value, for example, for which purpose a look-up table can be prepared. The actual message is only produced as clear text by this conversion. The schemes preferably do not contain any raw values, but rather interpretable characters such as an ASCII text so that the message and the schemes work on the same and intuitively more easily detectable plane of the clear text due to the conversion.

The characters of the message with their characters taken over from a scheme are preferably converted into raw values to determine the second check code. Check codes are typically calculated on the level of raw values. The second check code can therefore not be sensibly determined from a scheme or from a message that was corrected by a scheme on the level of converted characters or of the clear text. The corrected message is rather previously translated into raw values again in accordance with this embodiment, in a reversal of the conversion of the previous paragraph, now for the corrected message. For this purpose, the look-up table of the original conversion can be used in the reverse reading direction. It may be meaningful for reasons of implementation to use a reordered inverse look-up table.

Control characters of the read raw values are preferably considered in the determination of the second check code. In the previous paragraph, the problem was discussed that a second check code does not even reproduce the first check code in the error-free case when the second check code is calculated from clear text. Moreover, however, possibly still invisible characters or control characters of the original raw values have been lost in the clear text that have, however, entered into the first check code. Such control characters are therefore buffered in this embodiment and are taken into account in the correct positions on a reconversion of the corrected message into raw values so that the control characters enter into the second check code in a manner comparable with the first check code.

A check is preferably made for a plurality of schemes whether a minimum portion of the characters of the scheme is relocated, i.e. found, in the message, with characters of the scheme being taken over into the message experimentally for every scheme to which this applies and with a second check code being determined with respect to the message thus corrected and with that scheme and that message corrected by it being considered validated whose second check code agrees with the first check code. There are therefore at least two schemes or even a whole pool of potentially matching schemes here that can be applied to a read message. A criterion for the correct scheme is that its expected characters match the characters of the message to as high a degree as possible. The invention now makes a further very distinct criterion possible, namely whether the matching second check code is calculated after the correction by a scheme. The correction by such a scheme can be trusted with high reliability.

For the case that the second check code agrees with the first check code for more than one scheme, the message is preferably considered as not validated. It is not particularly likely, but still possible, that the correction of the message by two different schemes respectively results in the correct second check code by an error accumulation. It may be sensible in such exceptional cases to treat the corrected message as a reading error again since at least one of the two corrections cannot be correct. Alternatively, the respective corrected messages can be output and correspondingly marked. Which message is the correct one can possibly subsequently be decided by higher ranking, for example content related, criteria or a manual selection is made possible in this manner by only two or a few candidates instead of a full post-processing completely without code information. It must still be noted that two different schemes can randomly produce the same corrected message; this special case should preferably be intercepted because it naturally also represents a proper validation.

Schemes have previously only be introduced by known characters at fixed positions. This is what is called a fixed character or fixed portion in EP 4 258 160 A1. A scheme can furthermore have a variable portion that will now be described. All the features related to the variable portion are optional. Reference is again made to EP 4 258 160 A1 for further details. A variable portion means that the scheme contains a variable character that is expected at this position in codes to be read for at least one position of the message, with a variable character being set to a partial range of the possible characters, but not to a fixed character. Typical examples for a variable character are numerals or letters. The comparison of the read characters of the message with the scheme preferably includes the variable portion. If a character of the message is read at a position here that does not correspond to the scheme, this is an indicator that this scheme does not match the read message. A numeral is, for example, read at a position of a variable character at which a letter should be according to the scheme. A different scheme is then preferably used, the correction by this scheme is dispensed with, or the missing match is at least noted as a further evaluation criterion of the validation. In accordance with its definition, fixed characters and variable characters preclude one another and as a consequence their respective positions in accordance with the scheme differ.

The scheme preferably has a code length and/or contains a fixed character or a variable character for every position. The scheme thus includes information on the code length, the total number of characters of the message. The scheme is preferably complete; which fixed character is there or which partial range of possible characters is possible as a variable character there is therefore known from the scheme for each position of the message. The code length that can, however, nevertheless additionally be an explicit parameter of the scheme is implicit in this completeness. A scheme can also be incomplete; there is then at least one completely free character in the limits of the general code specification. This can in particular be a temporary state during a teaching of a scheme.

A character not falling into the partial range of the characters possible for the variable character or a non-readable character at a position of a variable character is preferably corrected by means of the checksum and the result is only accepted as a correctly read message when the corrected character falls in the partial range of the characters possible for the variable character. A correction using the checksum takes place in the variable portion here. It was explained in the introduction that this is only possible for individual errors and additional MisReads can be generated in the case of multiple errors. The checksum can generally only either verify the integrity of the message or can be used for correction because the correction ultimately forces the integrity with the checksum. The scheme here makes possible an additional safeguarding since the corrected message still always has to satisfy the scheme. At least some of the additional MisReads are thereby intercepted.

A message whose length does not agree with the code length of the scheme or that has a character at a position of a variable character that does not fall in the partial range of the characters possible for the variable character is preferably classified as a Misread. The code length and the specifications of the scheme with respect to variable characters enable MisReads to be at least partially still discovered in the multiple error case.

A scheme preferably has at least one of the following partial ranges of possible characters of a variable character: non-printable characters, special characters, numerals, letters, lower case letters, upper case letters. These are particularly suitable examples for divisions or classes of the characters conceivable in a message. The division could take place completely at random in principle. Such semantic classes, however, facilitate the understanding for the user so that the use can be diagnosed and optimized more easily. In addition, regularities in codes are likewise rather to be found in the form of semantic classes as any desired divisions in practice. The possible characters of a code are frequently represented by numbers 0 . . . 127 of the ASCII code. Said partial ranges can be found in the ASCII code again.

A scheme is preferably formulated as a regular expression that indicates the permitted characters for the respective positions. A regular expression makes it easy for the user to understand and optionally edit the scheme. The internal processing is simultaneously facilitated and the error susceptibility on the programming of the decoders is reduced. Alternatively, a proprietary definition of schemes is conceivable that, however, preferably at least approximately reaches the clarity and formal regularity of regular expressions.

A plurality of read messages are preferably evaluated to teach a scheme, with the read messages in particular being detected in operation or loaded from a logfile. Directly specifying a scheme, either by parameterization in a user interface, in particular a graphical user interface, or by reading by means of data carriers or a network would admittedly generally be conceivable. This is absolutely of advantage for the diagnosis or improvement of schemes. In this embodiment, however, an automatic teaching is provided that liberates the user from this work. The teaching is based on read messages that can preferably originate from the ongoing operation or from an earlier operation, in particular a logfile. An adaptation of schemes during operation is furthermore conceivable. It is of advantage if it is known that the messages from which the scheme is taught are correctly read messages. In addition, only reading results are preferably used that were correctly read from the start and in particular have not experienced any correction from the checksum. However, a scheme could, for example, even be deduced from read messages by statistical processes when characters are missing in some messages and/or some messages contain incorrect characters. A sorting of the read messages preferably takes place in the teaching so that only codes from a code family can enter or a plurality of schemes can be taught for a plurality of code families. The code length, but also parts of the schemes themselves, in particular different fixed portions, can be criteria for the sorting. It can therefore occur in the course of the teaching that two or more schemes are formed from one scheme due to differences in the fixed portion.

A scheme is preferably taught from a distribution of read characters at the respective positions of the read message. Which characters occur at the respective positions of the message is accordingly determined. How often a character was read at the respective position can additionally be counted.

The corresponding fixed character is preferably taught at positions at which the same character is always read and the partial range formed therefrom is taught as a variable character at positions at which different characters are read. A character always read the same again at a position is thus assigned to the fixed portion of the scheme. Additional specifications can be made here, for instance that the fixed portion forms a block of adjacent characters or is at the start or at the end of the message. If the read characters vary at one position, the partial range spanned thereby is considered as a variable character of the scheme. This partial range can optionally still be expanded to discover a particular partial range as a whole. If, for example, the characters 1, 3, 5 were read at one position, the partial range can consist of exactly these characters {1, 3, 6} depending on the embodiment, of the whole spread {1, 2, 3, 4, 5, 6} between the read smallest and largest characters 1, 6 also including the non-read characters 2, 4, 5 or of the complete class of numerals. If practically any desired random characters were read at a position, neither a fixed potion nor a useful variable portion can be taught for the scheme here. A blank remains in the scheme, a variable character practically without restriction remains, or the teaching is aborted. An attempt can furthermore be made to find a partial set of the read messages in which overshoots are eliminated that have brought about this situation. The outliers can be output so that the user has a possibility to check whether it is justified not to take account of these read messages in the scheme.

A scheme is preferably first initialized with blank regions per position, the respective first character read at a position is stored for this position, and every character that is read at a position after the first character for this position and that was still unknown for this position expands the partial range for this position such that the read character is covered. This is an advantageous implementation of the teaching of schemes. In this respect, sorting is as always preferably performed such that the read messages from which the respective scheme is taught belong to the same code family. A blank scheme is initialized that initially has no prior knowledge for any position. A respective character read at a position is first considered as a fixed character of the scheme. This should then be confirmed via the further read messages. It can also be required that a fixed character was read at least m times or m of n times. If a different character is read at a position, this can be considered as an outlier in accordance with an m of n criterion. The characters previously read at this position preferably span the partial range of a variable character. The partial region can be expanded with every newly read character at a position of a variable character. The partial range should preferably remain restricted to a class such as numerals or letters; otherwise a particularly large partial range or an error message of the teaching is conceivable because no regularity or systematics can be recognized at this position that can be sensibly detected in a scheme.

In a preferred further development, an optoelectronic code reader is provided having at least one light reception element for the generation of image data from received light and having an internal and/or external control and evaluation unit in which a method in accordance with the invention for reading optical codes is implemented.

The invention will be explained in more detail in the following also with respect to further features and advantages by way of example with reference to embodiments and to the enclosed drawing. The Figures of the drawing show in:

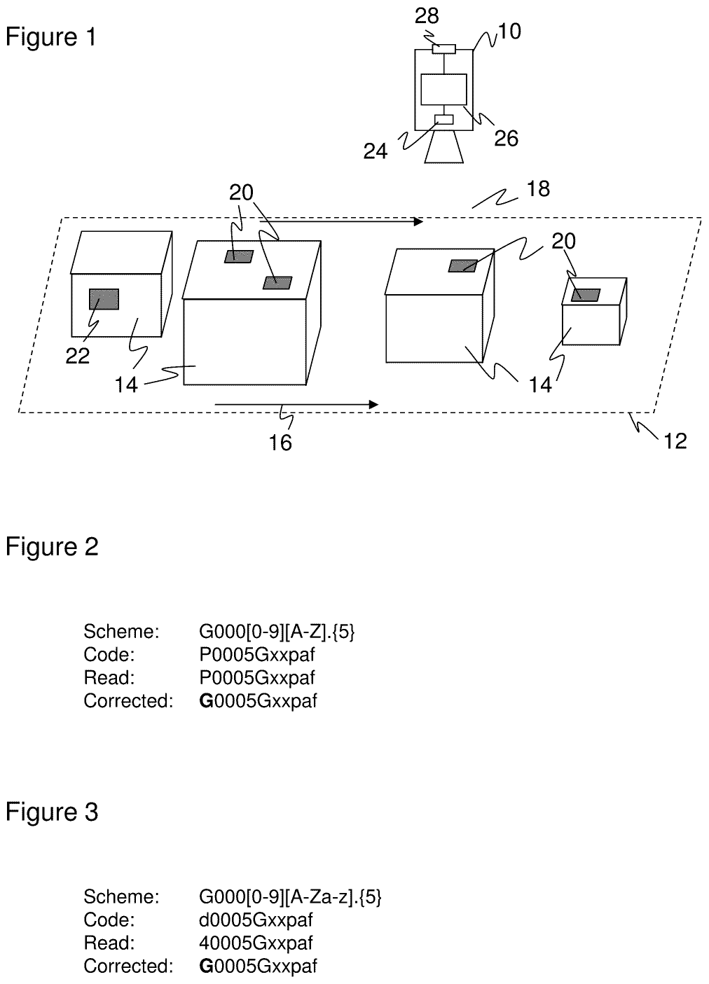

FIG. 1 a schematic overview representation of a code reader that is installed by way of example above a conveyor belt on which objects having optical codes to be read are conveyed;

FIG. 2 an example for a correction of a read code by means of a scheme that generates an error;

FIG. 3 an example for a correction of a read code by means of a scheme that does not remedy an error;

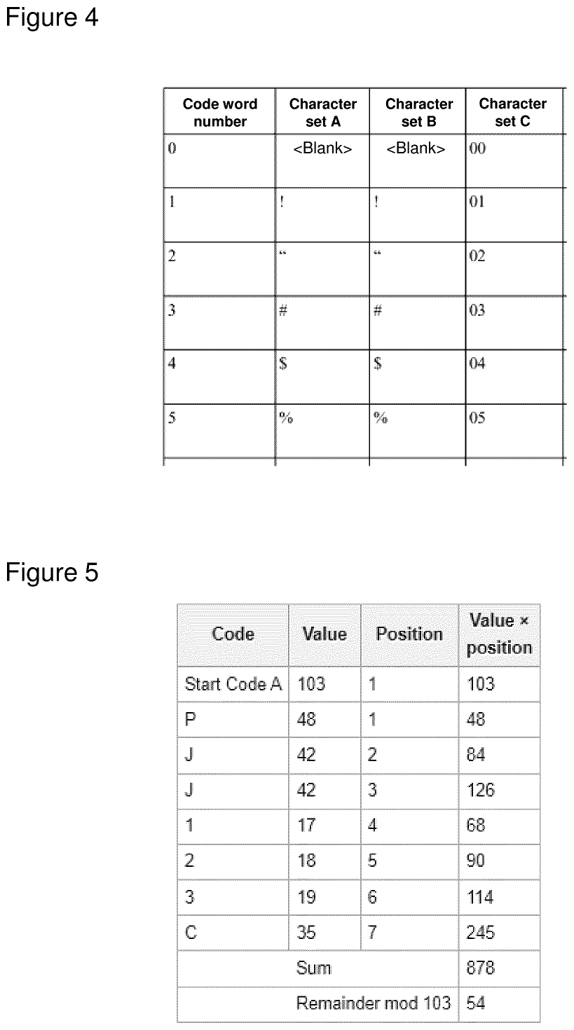

FIG. 4 a table to convert raw values in clear text for the example of the type Code128;

FIG. 5 an exemplary calculation of the check code for a message of a code of the type Code128;

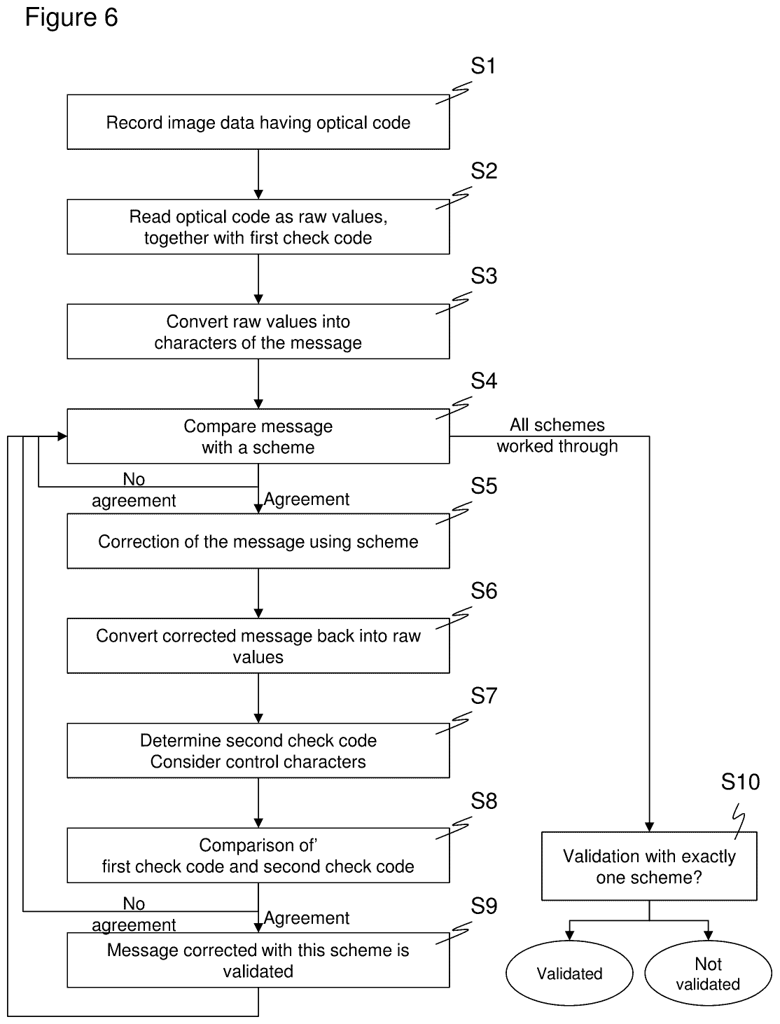

FIG. 6 an exemplary flowchart for correction by means of schemes and validation of the corrected messages by a check code; and

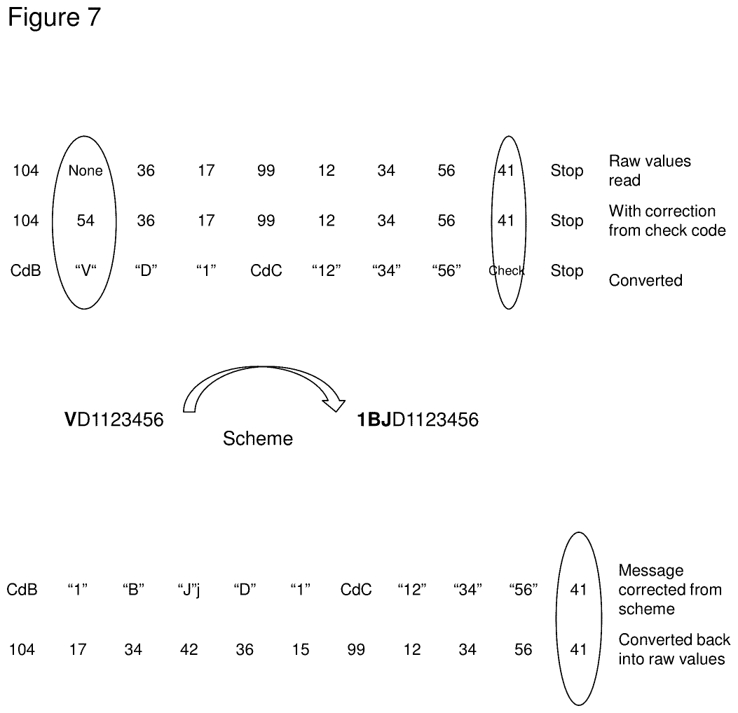

FIG. 7 a specific example of a read code to illustrate the correction and validation by means of schemes.

FIG. 1 shows an optoelectronic code reader 10 which is mounted above a conveyor belt 12 which conveys objects 14 through the detection zone 18 of the code reader 10, as indicated by the arrow 16. The objects 14 bear code zones 20 on their outer surfaces which are detected and evaluated by the code reader 10. These code zones 20 can only be recognized by the code reader 10 when they are affixed to the upper side or at least in a manner visible from above. Differing from the representation in FIG. 1, a plurality of code readers 10 can be installed from different directions for the reading of a code 22 affixed to the side or to the bottom, for instance, in order to enable a so-called omnireading from all directions. The arrangement of the plurality of code readers 10 to form a reading system mostly takes place as a reading tunnel in practice. This stationary use of the code reader 10 at a conveyor belt is very common in practice. The invention, however, relates to the reading of codes or to the code reader 10 itself so that this example may not be understood as restrictive. Codes can also be scanned by hand, for example, or a code or an object 14 having a code can be held in the reading field of the code reader 10 in a presentation application.

The code reader 10 detects image data of the conveyed objects 14 and of the code zones 20 by a light receiver 24 and said image data are further processed by a control and evaluation unit 26 by means of image evaluation and decoding processes. The control and evaluation unit 26 comprises, for example, at least one processing module such as a microprocessor or a CPU (central processing unit), an FPGA (field programmable gate array), a DSP (digital signal processor), an ASIC (application specific integrated circuit), an AI processor, an NPU (neural processing unit), a GPU (graphics processing unit), a VPU (video processing unit), or the like. It is not the specific imaging process that is furthermore important for the invention so that the code reader 10 can be set up in accordance with any principle known per se. For example, only one respective line is detected, either by means of a linear image sensor or by means of a scanning process, and the control and evaluation unit assembles the lines detected in the course of the conveying movement to form the image data. A larger zone can already be detected in a recording using a matrix-like image sensor, with the assembly of recordings here also being possible both in the conveying direction and transversely thereto. The central function of the code reader 10 is the decoding, i.e. the reading of the message encoded in an optical code as clear text. The message is a character chain of utility characters, preferably with at least one check character that is typically at the end. The code reader 10 outputs information such as messages read from the codes or image data via an interface 28.

A correction of the respective message read from a code and its validation will be explained in the following with reference to FIGS. 2 to 7. It is preferably carried out in the control and evaluation unit 26. It is, however, equally conceivable to output image data or intermediate results via the interface 28 and to outsource at least some of the decoding, correction, and/or validation to a higher ranking system such as a control processor, a network, or a cloud. Pre-processing of the image data for segmentation and for localizing code zones 20 and the decoding per se are assumed as known and not described.

FIG. 2 shows an example for a correction of a read code by means of a scheme that generates an error. An exemplary scheme is shown in the first line that has been specified or has been taught in one of the manners explained in the introduction. In accordance with the convention underlying the scheme here, “G000” is expected as the first four characters, which corresponds to the fixed portion of the scheme. A numeral, then an upper case letter, and then five arbitrary characters follow as the variable portion. Other conceivable schemes comprise a fixed portion having more or fewer characters, contiguous or distributed at the start, at the end, or at the middle in the scheme and no or another variable portion and other variations. The syntactic convention is likewise purely exemplary; the specifications of the fixed portion and/or variable portion can be noted in any desired manner. Reference is again additionally made to EP 4 258 160 A1 with reference to the possible embodiments of a scheme and its application to a code.

The actual code in the second line (ground truth) was originally already correctly read in the example of FIG. 2 in accordance with the third line. On the comparison with the template, however, the three zeros in the start part “P000” are sufficient with respect to “G000” that more than half the fixed portion of the template matches the read code. The template is therefore used for the correction and its fixed portion now overwrites the first four characters of the read code. The corrected code in the third line now has an error in its originally correctly read first characters. The example is simplified; it might possibly have been recognized at the read code in the second line using the check code or other criteria that no more schemes should be applied. It is here only a question of an explanation of the principle.

FIG. 3 shows a second example for a failed correction of a read code by means of a scheme that in this case does not introduce any error into an already correctly read code, but rather does not remedy an error in the reading of the code. The arrangement of the four lines is analogous to that of FIG. 2. In this case, however, the read code in line 3 is defective in its first character. The applied scheme with the leading characters “G000” is, however, only apparently the matching scheme due to agreement in the three zeros so that the defective first character “4” is overwritten by a likewise defective “G” instead of the correct “d”.

In both examples, a MisRead is produced under the incorrect assumption of a successful correction. This is prevented by the validation of the corrected messages in accordance with the invention now to be explained. The basis of the validation is the read check code or the check digit of the optical code that is called the first check code to distinguish terms. A second check code is then calculated from the corrected message that has to agree with the first check code for a successful validation. The calculation of the second check code is, however, not so easy as it looks at first glance since the corrected message in clear text forms an insufficient basis at least for a large number of code types.

This is due to the fact that the code elements of the optical code initially only stand for raw values that are then translated into the clear text of the message depending on the type of code via its encoding scheme or alphabet. To look at this more closely, the example of Code128 is used in the following without limitation of the general applicability. Different barcodes or 1D codes use their own alphabets, which does not alter the basic principle, however. More powerful corrections are available for 2D codes, as briefly described in the introduction; the application of the invention with its schemes, a correction based thereon, and their validation by check codes is nevertheless also conceivable here.

FIG. 4 shows the start of a table to convert raw values into clear text for the selected example of the type Code128. Three alphabets or character sets are present here between which a switch can also be made by a control character still within a code. The table shows in the first column the raw values, also called reference code words or code word numbers, and in the further columns the utility characters or clear text characters associated with a respective raw value by the character sets A-C.

FIG. 5 shows an exemplary calculation of the check code for a message of a code of the type Code128. The check code is calculated as a weighted sum of the raw values modulo 103. The weighting starts at one and is respectively increased after the start character by one; start characters and other control characters also enter into the check code. The table shows this for the example of “PJJ123C” with a start character for the character set A.

To therefore calculate a comparable second check code, the encoding has to be reversed, for which purpose the table of FIG. 4 can be used in the reverse reading direction. In this respect, the start characters and other control characters have to be buffered and inserted in the correct positions. They are no longer contained in the clear text, in the example “PJJ123C”, but contribute to the check code.

A further requirement for the validation is that the check code has been correctly read. To be able to trust the check code, some conditions are therefore preferably made thereon individually or in combination. The value of the check code should first be permitted; for example, module 103 only valid values smaller than 103 can be produced. Furthermore, codes are read multiple times as a rule, thus also the check code, and it can be required that here the same check code has been read in the majority of cases or better always. The stop character should furthermore not have any defects and should also not have been corrected by a subsequent mechanism. The stop character is therefore used because it is at least the subsequent neighbor of the check code for most code types. The preceding neighbor can be checked in the same way. If the neighborhood of the check code does not have any defects, it is unlikely that the check code itself is damaged or has been read incorrectly for other reasons.

FIG. 6 shows an exemplary flowchart for correction by means of schemes and validation of the corrected messages by a check code. All the steps or only some steps are carried out depending on the embodiment. Image data having an optical code are recorded in a step 1. The optical code is first read in the form of raw values in a step S2; the first check code is also detected at the same time. The raw value is converted into a utility character or into clear text at least for most code types using an encoding scheme, as shown by way of example for Code128 in FIG. 4.

The read message is compared with a scheme in a step S4. A plurality of schemes can be considered that are then all used or are used in a partial selection consecutively for the comparison corresponding to the upwardly directed arrows on the left side of FIG. 6. A check is made in the comparison whether a minimum portion of characters from the scheme are found in the message as explained for an example with respect to FIG. 2. If this is not the case, the next scheme is tried. In the case of agreement, the message is corrected by the scheme in a step S5. The fixed characters of the scheme here overwrite the corresponding characters of the message.

The corrected message is reconverted into raw values in a step S6 for the now following validation. This is necessary if the message was converted from raw values into clear text in step S3 because the read first check code is based on raw values and comparability is only produced in this manner. The table of step S3 can be used in the reverse reading direction for the reconversion. The second check code is determined from the reconverted corrected message in a step S7. In this respect, the control characters from the read message must be considered in the correct position, as explained in connection with FIG. 5.

The first check code and the second check code are compared with one another in a step S8. If there is no agreement, the validation has failed and the next scheme is processed in step S4. If the check codes agree, the corrected second message is validated in a step S9. The method likewise returns to step S4 to process further schemes. Alternatively, discontinuation can take place here and the validated corrected message can be considered as the result of the code reading.

If no further schemes are available in step S4, the loop is ended and a check is made in step S10, following the arrow of FIG. 6 breaking out to the right of the iteration, whether the validation was successful with exactly one scheme. The corrected message is considered as validated in this case, otherwise not. The corrected message is thus not validated if no scheme has produced a correction. It should, however, preferably not occur that a plurality of schemes simultaneously result in a corrected message with a matching second check code. An error accumulation then occurred; both corrected messages cannot be correct. It should still be intercepted as an exception that a plurality of schemes have randomly produced the same corrected message; this is then not an ambiguity in the sense of the right path from step S10.

FIG. 7 shows a specific example of a read code to illustrate the correction and validation by means of schemes. The read raw values are shown in the first line of the upper part of FIG. 7. No raw value could be determined at position two. This value was corrected to 54 with the aid of the check code in the second line. This is to this extent only the conventional correction from a check digit and, as will be found, is not the correct connection. The raw values are then converted into utility characters or clear text in accordance with the encoding scheme of code 128 in the third line. In this respect, the character set B is used for the first characters in accordance with the control characters CdB or CodeB; a switch is then made from here onward to the character set C by means of CdC or CodeC.

The message resulting up to here of “VD1123456” is corrected by a matching scheme to “1BJD1123456” in the middle part of FIG. 7. As in the first line of the lower part of FIG. 7, the control characters CdB and CdC from the original message are reinserted to validate this corrected message because control characters enter into the check code. The corrected message together with the control characters are converted back into raw values in the last line, again in accordance with the rule of the encoding scheme of Code128, now in the reverse direction. The second check code is calculated from this that agrees with the originally read first check code and thus validates the corrected message.

It will finally still be explained for better understanding how the error case in the second position of FIG. 7 can arise at all. An attempt was first made here to correct the second position from the first check code. The actual situation is different, however: Not only a single character is read; in actual fact, three whole characters are missing at this point due to damage. A correction via check codes can thus not manage and was not the appropriate way of dealing with things. In addition, the correction via check codes invalidates the original purpose of the check code since the first check code naturally matches the read message by design; the gap was actually filled from this condition. Only the correction and validation in accordance with the invention can replace or supplement the missing characters via their schemes and can also demonstrate that this was the appropriate correction.

1. A method of reading an optical code that encodes a message that has a character chain having a plurality of characters, said method comprising the steps of
recording image data having the optical code;
evaluating the image data by reading the message, including a first check code read from the optical code;
comparing the read characters of the message with at least one scheme that, for a plurality of positions of the message, contains a character that is expected at this position in optical codes to be read;
and, when a minimum portion of the characters of the scheme are relocated in the message on the comparison, taking over characters of the scheme into the message,
wherein a second check code of the message is determined after a taking over of characters from a scheme into the message; and wherein the first check code is compared with the second check code to validate the message changed by taking over characters from the scheme.

2. The method in accordance with claim 1,
Wherein the minimum portion of the characters of the scheme comprises at least two characters or at least half the characters of the scheme.

3. The method in accordance with claim 1,
wherein all the characters of the scheme are taken over into the message,

4. The method in accordance with claim 1,
wherein the first check code is considered as read correctly when the first check code is within a permitted value range, when the same first check code results in at least a majority of cases with a redundant multiple reading, and/or when directly adjacent characters of the check code were read.

5. The method in accordance with claim 1,
wherein the message is first read in raw values from optical elements of the optical code, with the raw values then being converted into the characters of the message using an encoding scheme of a code type.

6. The method in accordance with claim 5,
wherein the characters of the message with their characters taken over from a scheme are converted into raw values to determine the second check code.

7. The method in accordance with claim 6,
wherein control characters of the read raw values are considered in the determination of the second check code.

8. The method in accordance with claim 1,
wherein a check is made for a plurality of schemes whether a minimum portion of the characters of the scheme is relocated in the message, with characters of the scheme being taken over into the message experimentally for every scheme to which this applies and with a second check code being determined with respect to the message thus corrected, and with that scheme and that message corrected by it being considered validated whose second check code agrees with the first check code.

9. The method in accordance with claim 6,
wherein, for the case that the second check code agrees with the first check code for more than one scheme, the message is considered as not validated.

10. An optoelectronic code reader having at least one light reception element for generating image data from received light and having a control and evaluation unit in which a method of reading optical codes in accordance with claim 1 is implemented.
